(19) United States
(12) Patent Application Publication
(10) Pub. No.: US 2019/0166657 A1
(43) Pub. Date: May 30, 2019

(54) POT DETECTION SENSOR FOR AN INDUCTION HOB, AND INDUCTION HOB

(71) Applicant: E.G.O. Elektro-Geraetebau GmbH, Oberderdingen (DE)

(72) Inventors: Karl-Heinz Benz, Eppingen (DE); Marcus Frank, Sulzfeld (DE); Daniel Parker, Koenigsbach-Stein (DE); Dennis Schmid, Kraichtal (DE); Martin Volk, Oberderdingen (DE)

(21) Appl. No.: 16/185,224

(22) Filed: Nov. 9, 2018

(30) Foreign Application Priority Data
Nov. 28, 2017 (DE) 10 2017 221 341.8

(51) Int. Cl. H05B 6/12

(52) U.S. Cl. CPC H05B 6/1218; H05B 2213/05; H05B 6/1272

(57) ABSTRACT

A pot detection sensor for an induction hob has an air-core coil with at least two turns and has a carrier for the air-core coil. A length of the air-core coil can be at least five times, advantageously ten times, a width of the air-core coil. Diffusor means can be arranged, as a housing, over at least one lighting means for the purpose of equalizing a lighting effect of the one lighting means, wherein a single and continuous diffusor means is provided for all of the lighting means on a carrier. The diffusor means can form a housing over the at least one lighting means and also around the at least one lighting means. The air-core coil is advantageously wound around this housing.

### FIELD OF APPLICATION AND PRIOR ART

The invention relates to a pot detection sensor for an induction hob, and to an induction hob comprising at least one pot detection sensor of this kind.

US 20160150600 A1 discloses pot detection sensors which can be used in an induction hob. In this case, small sensor coils which are distributed over the surface of the induction hob are provided. Said sensor coils are situated in regions between two adjacent induction heating coils, but in some cases also precisely over an induction heating coil. Owing to the large number of sensor coils, it is possible to identify, possibly together with the induction heating coils themselves, whether a cooking vessel has been placed onto the induction hob and, if this is the case, where it has been placed.

Furthermore, US 20090321413 A1, for example, discloses providing lighting means or illumination elements beneath a hob plate of an induction hob. Said lighting means or illumination elements can display different information, or possibly even have only a decorative purpose.

### PROBLEM AND SOLUTION

The invention is based on the problem of providing a pot detection sensor of the kind mentioned in the introductory part and also an induction hob of the kind mentioned in the introductory part, by way of which pot detection sensor and induction hob problems in the prior art can be solved and it is possible, in particular, to be able to detect the position or the set-down location of cooking vessels on the induction hob in a simple, precise and reliable manner.

This problem is solved by a pot detection sensor having the features of Claim 1 and also by an induction hob having the features of Claim 19. Advantageous and preferred refinements of the invention are the subject matter of the further claims and will be explained in more detail below. In the process, some of the features will be described only for the pot detection sensor or only for the induction hob. Irrespective of this however, the intention is that said features are applicable both to the pot detection sensor and also to the induction hob separately and independently of one another. The wording of the claims is incorporated in the content of the description by express reference.

Provision is made for the pot detection sensor to have an air-core coil which has at least two turns, advantageously more, for example ten to fifty turns. The pot detection sensor has a carrier for the air-core coil, wherein this carrier can simultaneously be the supporting component for the entire pot detection sensor. However, the air-core coil does not have to be fitted directly onto the carrier for this purpose.

According to the invention, a length of the air-core coil is at least five times a width of the air-core coil, so that said air-core coil can therefore be designed as elongate and, in particular, as elongate and narrow. As a result, the pot detection sensor can likewise be of narrow design overall and can be very readily incorporated in an induction hob comprising at least one induction heating coil, in particular when the induction hob has a plurality of induction heating coils and a pot detection sensor of this kind is provided between adjacent induction heating coils. In this case, said pot detection sensor covers only a small surface area and, as it were, does not cause interference when it is installed, in particular does not have an interfering effect on the arrangement and functioning of the induction heating coils or does so only as little as possible. Said induction heating coils are often specifically at a lateral distance from one another so that cooking vessels which are respectively placed down do not obstruct one another either. A pot detection sensor of this kind can advantageously be positioned in this spacing.

The advantage of a pot detection sensor comprising an air-core coil which is elongate is that, in comparison to a pot detection sensor from the prior art with a round air-core coil, it can not only detect or monitor whether a cooking vessel has been placed over it as it were at one point or in a very small region, but rather can monitor whether a cooking vessel has been set down over it in a considerably larger region or even along the length of the air-core coil.

In a refinement of the invention, the carrier is flat, in particular a flat material like, for example, a printed circuit board or a similar thin carrier. The turns of the air-core coil preferably run parallel to the carrier. The configuration of a carrier as flat or planar has the advantage that it then takes up as a little installation space and overall height as possible. Said turn profile also makes a contribution to this. Therefore, the pot detection sensor can even be arranged between the induction heating coil and the bottom side of a hob plate, without disadvantageously changing the overall height of the induction hob or without the induction heating coil having to be at a greater distance from a bottom side of the hob plate than necessary. Furthermore, a carrier of this kind can also be used for further components or groups of components which can also serve to actuate and/or evaluate a pot detection operation. As an alternative, said components or groups of components can be provided for other functions, as will be explained in detail further below.

In an advantageous refinement of the invention, the air-core coil and/or the carrier are straight. This is suitable primarily when the induction heating coils of the induction hob have a polygonal external shape or have an at least partially rectilinear outer shape or outer sides. In this case, a pot detection sensor of this kind can be arranged with an, as it were, matched shape along these straight outer sides.

In the alternative, as is easy to imagine, the air-core coil and/or the carrier can be of bent design. Here, the bent shape could be, in particular, a partially circular shape which can be particularly effectively used when an induction heating coil of the hob has a rounded or circular shape over at least a portion of its outer side. The profile of the air-core coil or of the pot detection sensor can then also be matched to the profile of the outer edge or outermost turn of the induction heating coil here.

In a possible refinement of the invention, the ratio of length to width of the air-core coil can be, as it were, even narrower, so that a length of the air-core coil is between eight times and twelve times its width. Owing to the small width, the air-core coil or the pot detection sensor do not cause interference between two induction heating coils, but a relatively large or at least long region can nevertheless be monitored to check whether a cooking vessel has been set down. In particular, the pot detection sensor together with the air-core coil can be as long or almost as long as a longitudinal side of an induction heating coil which faces an adjacent induction heating coil. It goes without saying that this applies primarily in the case of air-core coils and/or pot detection sensors of straight design.

A length of the air-core coil can be at most 30 cm or at most 25 cm. In particular, an air-core coil can be at most 20 cm long, so that it can primarily also be used in induction hobs of the kind which have more than the usual four or six induction heating coils.

A width of the air-core coil should be at most 3 cm, in particular at most 1 cm or 2 cm. A specific minimum width, for example 3 mm to 5 mm, is considered to be advantageous and almost necessary so that the pot detection function of the air-core coil is good enough. However, owing to the limited space conditions in an induction hob, its width should not be excessively large and even, as mentioned above, not lie above 2 cm to 3 cm as far as possible. Since an air-core coil advantageously does not cover the induction heating coil or its outer turns, said air-core coil should be arranged in the intermediate space between the outer turns of adjacent induction heating coils and, as it were, have enough space, for which reason it should likewise not be excessively wide. Otherwise, the functioning of the induction heating coil, and possibly also the functioning of the air-core coil itself, could be adversely affected.

In a yet further refinement of the invention, the carrier advantageously has two opposite flat sides, in particular if it is a flat and planar carrier. The carrier should be fitted with components only on that flat side on which the air-core coil is also arranged. In this case, it is possible for the other flat side to be free of components. If the carrier is a printed circuit board or the like, electrical contacts and/or contact tracks, contact areas and/or plated through-holes can then be provided on both flat sides, but in order for the carrier to be able to be placed in a relatively flat manner on a substrate, for example onto an abovementioned carrying plate which carries the induction heating coils, or even onto the induction heating coils or the carrier thereof itself, the flat side which forms the bottom side of the pot detection sensor should likewise be as free of protruding components as possible. Since the other flat side with the air-core coil has a protruding and upwardly projecting component in any case, additional components can also further be provided here. As a result, there is no unnecessary excessive increase in the overall height in this case.

In a refinement of the invention, it is possible for a pot detection sensor to have not only one air-core coil but rather a plurality of, in particular two, air-core coils on its single carrier. This plurality of air-core coils can then be arranged in an extension to one another on the carrier; said air-core coils are advantageously identical. Therefore, said air-core coils can run either along a straight line or along a bend or circle. The distance of said air-core coils from one another can be between 1 cm and 5 cm, the distance advantageously corresponding approximately to a width of the air-core coils or of the carrier. Even if the two air-core coils have to be electrically separately actuated and evaluated for control purposes, complexity of assembly is nevertheless reduced because two air-core coils can be installed at the same time in one assembly process. The same applies for the electrical connection.

In a refinement of the invention, at least one temperature sensor is provided on the pot detection sensor. Said temperature sensor can be arranged on a top side of the pot detection sensor, for example as far as possible or largely at the top at the topmost point of the pot detection sensor, in particular on a housing or the like. In this way, said temperature sensor can bear against a bottom side of a cover or hob plate running above it and record or monitor the temperature of said cover or hob plate, as is known from temperature sensors above induction heating coils. In the alternative, said temperature sensor can be arranged on a bottom side of the pot detection sensor, in particular on the carrier and for example record the temperature of a carrying plate or the like beneath it on which the pot detection sensor and the induction heating coils are placed.

Furthermore, it is possible for the pot detection sensor to have a bus controller for the purpose of evaluating the air-core coil and possibly for the purpose of actuating further functional components on the carrier. This will be explained in more detail further below.

An abovementioned bus controller can advantageously also be provided when a pot detection sensor has lighting means. Lighting means of this kind can generally advantageously be arranged on the same flat side of the carrier as the air-core coil. Suitable lighting means are LEDs, in particular SMD LEDs, which are fitted on contact areas or conductor tracks on the carrier. In the alternative, the lighting means can also be arranged on, for example adhesively bonded onto, the air-core coil itself, so that they are then, as it were, carried by the air-core coil.

In an advantageous refinement of the invention, the lighting means are surrounded by the air-core coil since there is usually a sufficiently wide space within the air-core coil, see the statements made above. The lighting means can then, in addition to the function for pot identification, at the same time and completely independently thereof display information to an operator or provide optical effects on the induction hob or form a boundary for induction heating coils. The placement of cooking vessels onto the hob plate can then be considerably improved. The air-core coil therefore preferably surrounds the lighting means or runs around said lighting means.

For a visually pleasing appearance of the lighting means, diffusor means are advantageously provided in order to generate a diffuse light phenomenon or in order to equalize a lighting effect of the at least one lighting means which usually provides illumination in a rather spot-like manner. In this case, a single and continuous diffusor material can particularly preferably be provided for all of the lighting means on a carrier. Therefore, a continuous lighting phenomenon which is as uniform as possible and has approximately the length of the air-core coil or of the pot detection sensor can be achieved. Specifically within the scope of the invention, it has been found to be advantageous when not only the air-core coil is arranged in the region between two adjacent induction heating coils for the purpose of detecting a cooking vessel having been placed down and, in the process, also runs over a greater length, in particular over virtually the entire length of this intermediate region. In addition, this region is also of interest for optical marking for an operator, so that said operator can possibly set down a cooking vessel centrally onto the induction heating coil which is marked by means of a lighting phenomenon. In this case, known permanent cooking point markings on the top side of the hob plate can be dispensed with. In addition to marking cooking points, a lighting phenomenon of the lighting means can likewise also provide information to an operator of the hob, for example in respect of the state of the hob or of a cooking point or of a cooking vessel which has been placed thereon.

It is possible for an abovementioned diffusor means to be designed as a housing or to form at least a portion of a housing, and under certain circumstances an entire housing can also be composed of this material, possibly provided with a coating. This housing is primarily provided over the lighting means or is a housing for the at least one lighting means. Said housing can be designed as a cover in the form of a box. The housing preferably runs not only over the lighting means, but rather also laterally around the lighting means. A housing can be open at the bottom and, at the same time, it is possible to prevent light from shining from the lighting means to the outside in an undesirable manner by way of placing or setting down the housing onto the flat carrier.

In an advantageous further refinement of the invention, an air-core coil, by way of its turns, can be wound onto or around an abovementioned housing or around a cover for the at least one lighting means. In this case, the air-core coil is not situated directly on the carrier, but rather bears directly against the housing or against the cover in a planar manner, which housing or cover is then, in turn, carried by the carrier. As a result, it is possible, if the pot detection sensor has a housing of this kind or a cover of this kind, for said pot detection sensor to not only not cause interference for the air-core coil but rather also render it possible for the air-core coil to be wound on and therefore arranged in an effective and practical manner. Furthermore, the air-core coil can then be arranged relatively high over the carrier if this is desired, and therefore close to the bottom side of the hob plate and as close as possible to a cooking vessel which is placed on the hob plate over said air-core coil. This improves the accuracy of a pot detection operation. A further advantage of winding the air-core coil onto a housing of this kind or a cover of this kind is that this is firstly possible in a relatively simple manner and secondly an accurately prespecified type of winding and form of winding for the air-core coil can be achieved. If the pure air-core coil had to be fastened on a flat carrier or a printed circuit board, it would have had to be wound onto a different winding core which is then fastened on the carrier. As an alternative, the air-core coil would have to be removed from the core after being wound on and inherently fixed, for example by dipping lacquer, adhesive tape or adhesive. The problem of stable and permanent fastening on the carrier still remains in this case, and for this reason further components or functional elements or adhesive would be required. This is not the case with an abovementioned housing or a cover onto which the air-core coil can be wound. The housing or the cover can also be of special design on a laterally outer side in order to simplify winding of the air-core coil as far as possible. However, this is known from the prior art and does not need to be explained further here.

In a refinement of an induction hob according to the invention, provision can be made for the pot detection sensor or primarily the air-core coil to not cover an induction heating coil or a turn of an induction heating coil, in particular the outermost turn of said induction heating coil. The functioning of both coils can be optimized in this way. Nevertheless, the pot detection sensor or primarily the air-core coil should be arranged relatively close to an outermost turn of the induction heating coil, in particular at a distance of less than 4 cm. The distance can particularly preferably lie between 2 mm and 1 cm. In this case, the distance between two adjacent induction heating coils can be relatively small and the pot detection sensor or the air-core coil thereof can nevertheless run between said induction heating coils. In induction hobs of this kind, also according to US 20160150600 A1 as mentioned in the introductory part, provision can specifically also advantageously be made for a cooking vessel, in particular a relatively large cooking vessel, to be deliberately placed over two induction heating coils and to be simultaneously heated by both said induction heating coils. Corresponding correct placement or coverage can be detected by means of the air-core coil as pot detection sensor. However, furthermore, the distance between the adjacent induction heating coils should not be excessively large in order to render possible a desired power density and a heating power which is distributed as uniformly as possible over the surface of the base of the cooking vessel without an excessively large gap between the induction heating coils on account of the distance.

An induction hob can have, for example, at least two x three induction heating coils, advantageously at least two rows from left to right containing at least three induction heating coils in each case. At the locations at which two induction heating coils are adjacent to one another, pot detection sensors of said kind, in particular identical pot detection sensors, are provided in the intermediate regions. The induction heating coils are then advantageously rectangular or approximately rectangular or have at least partially straight outer sides. In this case, provision can be made for pot detection sensors to not be provided on the outwardly directed longitudinal sides of the induction heating coils which are not situated in the direction of an adjacent induction heating coil. Here, an operator themselves can generally identify when a cooking vessel protrudes to a very great extent beyond said outer sides of the induction heating coil since they are generally arranged close to a lateral or rear outer edge of the hob plate and the cooking vessel would then accordingly protrude beyond them. This can admittedly be intuitively avoided by an operator. The same applies in respect of the front edge, even though a wider region of the hob plate as operator control device or operator control panel is possibly formed here.

A housing or a cover over the lighting means can be elastic or flexible at least in the upper region. As a result, it is particularly readily possible for this top side to be pressed directly against a bottom side of a hob plate, without there being a risk of damage. A silicone material is suitable here, in particular translucent silicone material which, as is known, combines all of the functions of a housing, diffusor means and protective bearing contact. For specific symbol displays, the top side of the housing can also be closed in a light-blocking manner and have cutouts in the shape of a desired symbol, for example abstract characters, but possibly also letters or words. For the purpose of producing said characters, the top side can be completely covered or coated. A desired symbol or a desired cutout can then be cut by means of a laser or in a mechanical manner and then light from the at least one lighting means shines through said cutout from below and therefore illuminates said cutout.

A further advantage of the elongate design of the pot detection sensor or the air-core coil is that not only can, as it were, a digital signal be generated at one point, which digital signal states whether said air-core coil is covered by a cooking vessel or not. Instead, a kind of analog signal can be achieved or provided in this way, which analog signal reveals what proportion of the surface and therefore in particular of the length of the air-core coil is overlapped by a cooking vessel. This can render possible considerably improved localization of the cooking vessel which has been placed down, as would otherwise be possible only by using a very large number of small or spot-like pot detection sensors. A signal of this kind can allow a distinction from five to ten steps or stages to be made.

Provision can be made for a pot detection sensor to not be provided over an induction heating coil, in particular over the center point or central region of said induction heating coil. Here, the pot detection operation can be carried out by the induction heating coil itself in a known manner. This information can be readily processed together with the information from the pot detection sensors.

An electrical connection to the air-core coil of the pot detection sensor can be made at the side by means of a connection plug. A connection can also be provided jointly for lighting means which are fitted to the pot detection sensor, as a result of which the complexity of components and assembly can be reduced.

A pot detection sensor can be fastened to a carrying plate for induction heating coils of the induction hob, for example can be latched into corresponding recesses. Primarily elastic properties of an elastic material for the housing or the cover can be used for this purpose.

In a possible alternative, fundamental and advantageous refinement of the invention, only an elongate and narrow illumination device is provided for a hob, which illumination device runs between two induction heating coils. An elastic housing or at least one cover can be provided for the lighting means of said illumination device, so that no damage can occur when the illumination arrangement bears or is pressed against a bottom side of the hob plate. Furthermore, an elastic cover or an elastic housing can be of translucent design, in particular composed of silicone or soft plastic material, in order to achieve a lighting phenomenon which is as uniform as possible when individual lighting means, which light up in a spot-like manner, such as LEDs for example, shine light through said cover or housing. The cover or the housing can themselves in turn be designed and arranged as described above, and similarly they can have an above-described carrier. An illumination device of this kind therefore does not have to be a pot detection sensor with an abovementioned air-core coil; it serves only for illumination purposes.

These and further features can be gathered not only from the claims but also from the description and the drawings, wherein the individual features can be realized in each case on their own or as a plurality in the form of subcombinations in an embodiment of the invention and in other fields, and can constitute embodiments which are advantageous and which are protectable per se and for which protection is claimed here. The subdivision of the application into individual sections and subheadings does not restrict the statements made under them in terms of their general validity.

### BRIEF DESCRIPTION OF THE DRAWINGS

Exemplary embodiments of the invention are schematically illustrated in the drawings and will be explained in more detail below. In the drawings:

FIG. 1 shows a plan view of an induction hob according to the invention with the hob plate removed,

FIG. 2 shows a side view of a detail of an induction hob according to the invention having a pot detection sensor according to the invention,

FIG. 3 shows a cut-open view of the pot detection sensor from FIG. 2 from above looking at the lighting means together with actuation,

FIG. 4 shows an illustration of only the top side or cover of a housing of the pot detection sensor from FIG. 2,

FIG. 5 shows an alternative arrangement of a pot detection sensor of somewhat different design on a carrying plate of somewhat different design of an induction hob,

FIG. 6 shows the induction hob from FIG. 1 with pots of different sizes set down in different positions,

FIG. 7 shows an oblique view of a yet further refinement of a possible way of fastening a pot detection sensor to a carrying plate, and

FIG. 8 shows a plan view of a detail in the carrying plate from FIG. 7, in which a fastening shoe of a housing of the pot detection sensor can be fastened.

### DETAILED DESCRIPTION OF THE EXEMPLARY EMBODIMENTS

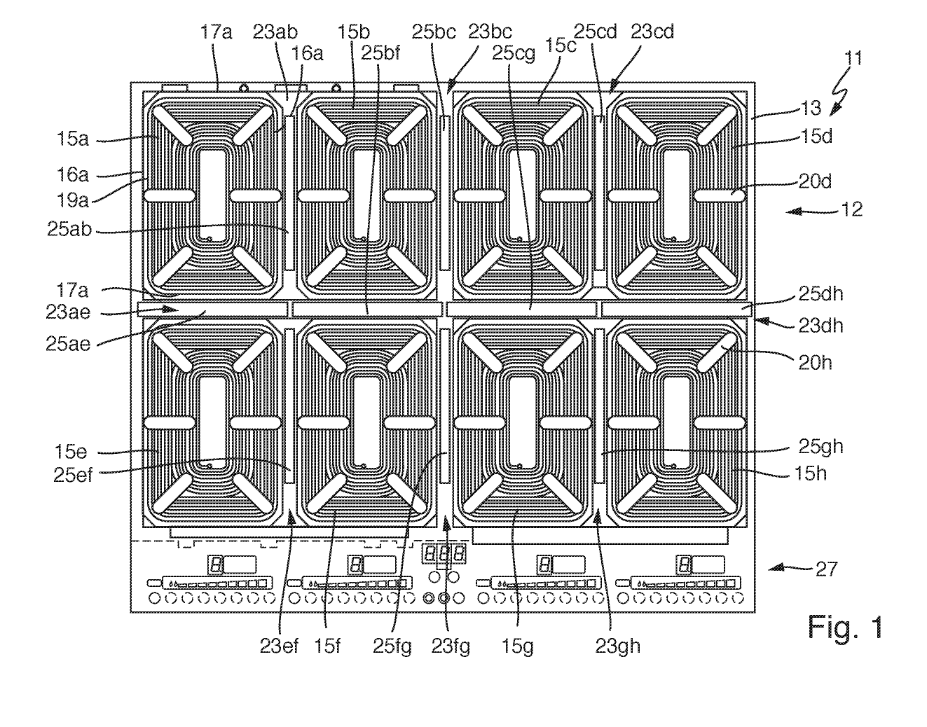

FIG. 1 shows a plan view of an induction hob 11 according to the invention, but with the hob plate removed or without a hob plate, that is to say a substructure 12 as it were. This substructure 12, as shown here, can be connected to a hob plate substantially in the usual manner. To this end, the substructure 12 has a carrying plate 13 which is then likewise connected to the hob plate by way of holders or the like.

Eight substantially rectangular induction heating coils 15a to 15h are arranged on the carrier plate 13. The induction heating coils 15 are all of identical design and identical orientation, as can be identified at least in the central region thereof at the outlet of a respective coil turn 19a to 19h at the bottom for the electrical connection. The induction heating coil 15a respectively has long sides 16a and short sides 17a. Said induction heating coil is somewhat rounded at the corners for the purpose of better guidance of the outer coil turn 19 since this should not be kinked. Nevertheless, induction heating coils with this shape should be considered to be rectangular or at least approximately rectangular below, as explained in the introductory part. This applies to all of the induction heating coils 15a to 15h.

Spacers 20a to 20h which can be composed of micanite or silicone are provided above the induction heating coils 15a to 15h. Ferrites can advantageously be fitted therebeneath as is customary. The coil turns themselves are fitted on coil formers, and these coil formers are then in turn arranged on the carrying plate 13.

It can be seen that the induction heating coils 15a to 15h are each at a certain distance from their adjacent coils, which distance can be, in practice, 1 cm to 3 cm or even 5 cm, wherein even smaller distances are preferred. As a result, neighboring regions 23, specifically firstly neighboring regions between long sides 16 of the induction heating coils, specifically the neighboring regions 23ab, 23bc, 23cd, 23ef, 23fg and 23gh, are formed. These neighboring regions 23 are all of identical width and identical length. Secondly, the induction heating coils 15 form further neighboring regions, specifically the neighboring regions 23ae, 23bf, 23cg and 23dh, at their short sides 17 which face one another or are adjacent to one another. These four neighboring regions are also each of identical length and identical width.

Pot detection sensors 25 are arranged in the neighboring regions 23. These pot detection sensors 25 are designed in the manner described in the introductory part; this will also be explained in more detail further below. A pot detection sensor 25 of this kind is arranged in each of the long neighboring regions, specifically the pot detection sensors 25ab, 25bc and 25cd in the top three long neighboring regions 23ab, 23bc and 23cd. The pot detection sensors 25ef, 25fg and 25gh are arranged in the three bottom long neighboring regions 23ef, 23fg and 23gh. In the case of these pot detection sensors 25 which are arranged in the long neighboring regions, it can be seen that they are each arranged precisely in the center of the neighboring regions 23 or precisely between the adjacent induction heating coils 15 or the long sides 16 thereof. The pot detection sensors 25 do not overlap with the induction heating coils 15, and not yet even with the coil formers thereof.

Pot detection sensors 25ae, 25bf, 25cg and 25dh are likewise arranged in the short neighboring regions 23ae, 23bf, 23cg and 23dh. Said pot detection sensors are also arranged precisely along a central longitudinal axis of the short neighboring regions and do not overlap the respectively top and the respectively bottom induction heating coil 15. These pot detection sensors 25ae, 25bf, 25cg and 25dh are at a very small distance from one another. This has proven advantageous within the scope of the invention for the purpose of registering pots which have been placed down.

Furthermore, the pot detection sensors 25ab, 25bc and 25cd in the top long neighboring regions 23ab, 23bc and 23cd are somewhat further away from a horizontal mirror axis through the pot detection sensors 25ae, 25bf, 25cg and 25dh than the pot detection sensors 25ef, 25fg and 25gh in the bottom long neighboring regions 23ef, 23fg and 23gh. This difference can be a few centimeters, but is clear. The displacement can be a few centimeters, for example 1 cm to 5 cm. A displacement of this kind can be provided, but does not have to be. It can also be the other way around. The vertically running pot detection sensors 25ab, 25bc, 25cd, 25ef, 25fg and 25gh could also reach almost as far as the horizontally running pot detection sensors 25ae, 25bf, 25cg and 25dh.

All of the pot detection sensors 25 are connected to a controller, not illustrated here, of the induction hob 11. A method for actuating said controller will be explained further below. In the front region, the induction hob 11 has an operator control region 21 with displays and operator control elements for setting the power of cooking points which are formed in various ways by one or more induction heating coils 15. Here, the controller, not illustrated, of the induction hob 11 can be arranged together with components for the operator control elements or a power setting.

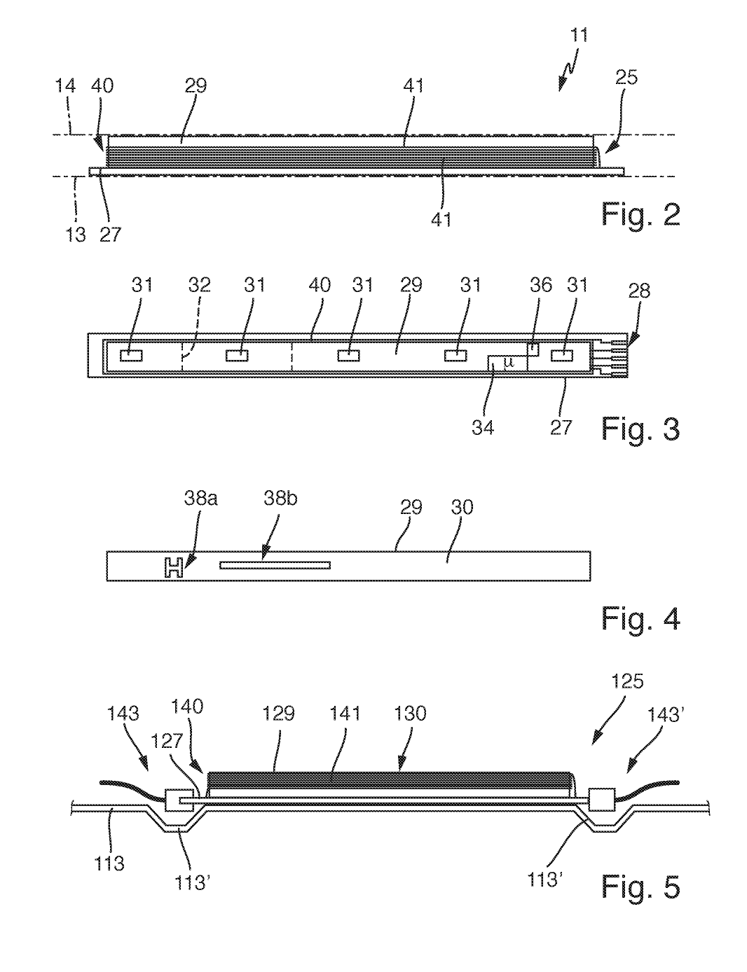

FIG. 2 shows a side view of a detail of a portion of an induction hob 11 according to the invention with a pot detection sensor 25. This pot detection sensor 25 is situated on a carrying plate 13, illustrated using dashed lines. Said pot detection sensor, by way of its top side, bears against the bottom side of a hob plate 14, illustrated using a dashed-and-dotted line.

As is also clear from FIGS. 3 and 4, the pot detection sensor 25 has an elongate narrow and flat printed circuit board 27. Said printed circuit board can have a length in the range mentioned in the introductory part, for example 15 cm to 25 cm, and a width of between 1 cm and 3 cm. Five contact areas 28, in particular designed as conventional copper conductor tracks, are provided in the right-hand side region of the printed circuit board 27 as carriers for the pot detection sensor 25. Said contact areas serve as an electrical contact which can preferably be designed as a so-called circuit board edge plug. However, primarily, a housing 29 which is set down directly onto the printed circuit board 27 and is also fastened on it or to it is arranged on the printed circuit board 27 as a carrier for the pot detection sensor 25. The housing 29 is elongate and rectangular, wherein it is somewhat narrower and somewhat shorter than the printed circuit board 27. The housing 29, by way of its top side 30, can be composed, in principle, of any desired material, advantageously of plastic or of silicone. Said housing should be opaque at the sides, either composed of opaque material or coated so as to be opaque on the inner side and/or the outer side. The housing 29 can also be at least partially opaque at the top side 30. This will be explained in more detail further below.

A plurality of LEDs 31 which are fitted on the printed circuit board 27 and also electrically connected thereto are provided in the at least partially hollow housing 29. Isolators 32, which are illustrated using dashed lines here, can be provided between individual LEDs 31. Said isolators form separate light channels for individual LEDs 31, so that it is possible to not only switch on and switch off illumination with all LEDs 31 overall, but rather it is possible to illuminate individual regions in a targeted manner with one or two LEDs 31, on the pot detection sensor 25.

A bus controller 34 and a temperature sensor 36 are illustrated on the printed circuit board 27 on the right-hand side in FIG. 3. The bus controller 34 serves for communicating with and/or actuating all of the electrical components which are arranged on the carrier. The temperature sensor 36 is not illustrated in any detail here but can advantageously be a resistance sensor, for example a PT1000, or a thermocouple. The temperature sensor 36 can, at the bottom, record the temperature on the carrier plate 13. In the alternative, it can, at the top, record a temperature on a bottom side of the hob plate 14 or on the bottom side 30 of the housing 29. Said temperature sensor is respectively advantageously correspondingly designed for this purpose, but this does not present any problems to a person skilled in the art. The temperature sensor 36 could also be provided outside the housing 29 on the printed circuit board 27; in the alternative, it can be arranged at the top of the housing 29, for example by means of a short cable or foil conductor. In addition or in the alternative, the temperature sensor 36 can also be used for recording the temperature of the LEDs 31 or of the bus controller 34 and therefore serve for monitoring a maximum permissible operating temperature of said LEDs or bus controller. In rare cases, the LEDs 31 could even be switched off if their specified operating temperature is exceeded. In the alternative, a heating power in this region can be reduced. This measure increases or ensures the service life of the LEDs 31.

As shown in FIG. 4, the top side 30 of the housing 29 has cutouts 38a and 38b of different design. The cutout 38a is designed as the letter “H” and can be illuminated, for example, as a symbol for a hot display. The cutout 38b is an elongate slot or is of elongate and narrow design. Therefore, a corresponding illuminated dash can be produced under the hob plate 14, which dash is visible through this hob plate 14. A dash of this kind could also be extended over a substantial or the entire length of the top side 30 in order to, for example in the case of an induction hob according to FIG. 1, correspondingly optically separate the induction heating coils from one another in order to display to an operator how the individual cooking zones approximately are running. This can then be displayed depending on the activation of the LEDs 31.

For illumination purposes, provision can be made for at least the top side 30, possibly even the entire housing 29, to be composed of a plastic or of a material which is inherently transparent but is only translucent or produces only diffuse light. Therefore, it can, at the same time, form an advantageously provided diffusor means which equalizes a lighting phenomenon of the rather spot-like LEDs 31 in a known manner. The housing 29 can then be coated in an opaque manner at the sides, either on the inside or on the outside. This can likewise be the case on the top side 30, wherein the cutouts 38a and 38b are left free during a coating process itself. In the alternative, coating can be performed over the entire surface, wherein the cutouts 38a and 38b and further possible and desired cutouts are then made, for example by laser, later. Under certain circumstances, this can even take place after fitting the induction hob 11 with the pot detection sensors 25 in a state in accordance with FIG. 1. Therefore, as it were, generic and general pot detection sensors can be installed, and they can then be individualized and/or processed for different lighting effects only in the installed state.

However, FIGS. 2 and 3 primarily show how an air-core coil 40 with a plurality of turns 41 is fitted on the pot detection sensor 25, specifically how these turns 41 are wound directly onto the outside of the housing 29. The individual turns 41 can, as illustrated here, be provided relatively far toward the bottom of the housing 29 or close to the carrier 27. In the alternative, they can also run centrally or at the very top, as is indicated in FIG. 5.

The air-core coil 40 is advantageously wound onto the housing 29 in one layer, for example with the abovementioned ten to forty turns. The air-core coil 40 is advantageously constructed from insulated copper wire. It can also be wound on in two layers if there is enough space or if the air-core coil is intended to be arranged as far as possible as a whole at the top of the housing 29 close to the hob plate 14.

For the purpose of easier winding, auxiliary means, not illustrated, can be provided on the outside of the housing 29, for example a protruding peripheral projection which can serve as a lower boundary and/or as an upper boundary for a winding operation. If a projection of this kind forms a lower boundary, it can also simultaneously prevent the turns 41 of the air-core coil 40 from slipping downward and therefore changing position, which would have a highly negative effect on their functioning.

The air-core coil 40 can be connected to the bus controller 34 and therefore can be electrically actuated and evaluated from the outside. This is easy to imagine per se and is known and does not need to be explained in any detail here.

In the exemplary embodiment of the pot detection sensor 25 of FIGS. 2 to 4, the printed circuit board 27 can be positioned, in principle, as desired on the carrier plate 13. It can be fixed by adhesive bonding, or in the alternative by recesses in the printed circuit board 27 which are plug-mounted onto protrusions in the carrying plate 13. Protrusions which engage into recesses in the carrying plate 13 can likewise be provided at the bottom of the pot detection sensor 25.

The alternative refinement of a pot detection sensor 125 of FIG. 5 shows how connections are plug-mounted onto the two ends of the printed circuit board 127. On the left-hand side, said connection is a connection plug 143 which is, as it were, open in a U-shaped manner. Therefore, it only has to be approximately as wide as the printed circuit board 127 itself or can even be somewhat narrower. A connection plug 143′ which protrudes somewhat beyond the printed circuit board 127 in terms of width is plug-mounted on the right-hand side. Therefore, it can be plug-mounted in a more stable manner.

Recesses 113′, here designed as depressions or stamped-out portions at the bottom, are provided below the connection plugs 143 and 143′ in the carrying plate 113, on which the pot detection sensor 125 is placed. A sufficient amount of space for the connection plugs 143 and, respectively, 143′ is created in this way. Said connection plugs can even be designed such that they are situated, as it were, in an interlocking manner in the recesses 113′ and therefore can prevent displacement of the pot detection sensor 125.

FIG. 5 also shows how an air-core coil 140, by way of its turns 141, is wound onto the outside of the side walls of the housing 129. Here, the air-core coil 140 is arranged relatively far at the top, that is to say close to a top side 130 of the housing 129. Therefore, it can be situated closer to a bottom side of a hob plate and therefore also closer to a cooking vessel which has been placed onto the hob plate, as a result of which said cooking vessel can be detected more effectively.

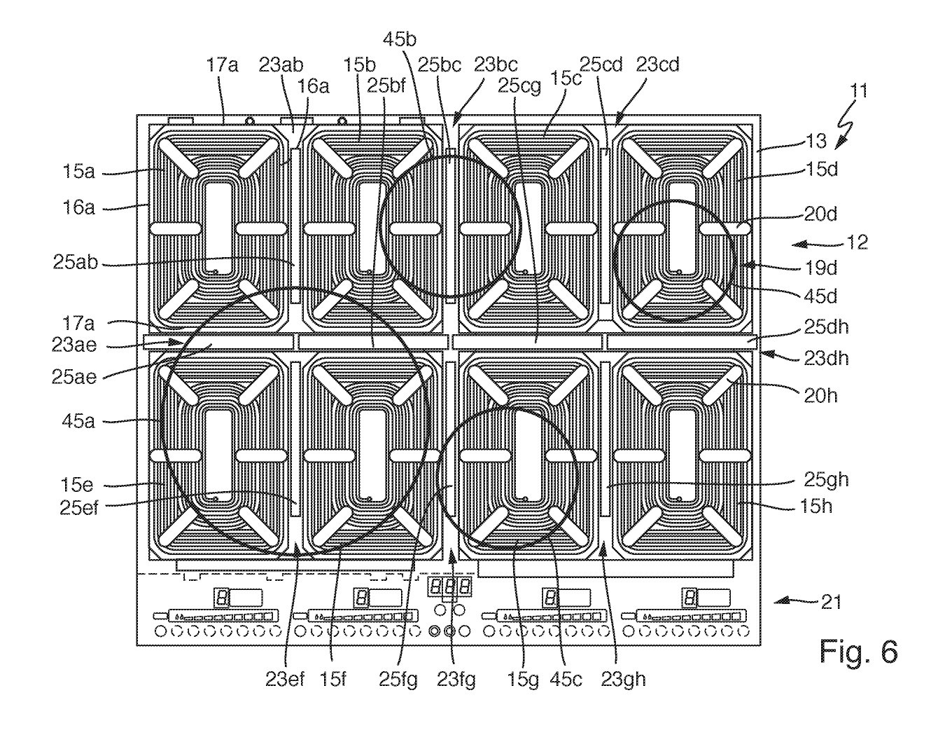

In FIG. 6, four different pots 45a to 45d are set down onto the induction hob 11 of FIG. 1. Here, the major advantage is the configuration of the pot detection sensors 25 as narrow and elongate between the induction heating coils 15.

The very large pot 45a at the front left is, by way of its front edge, almost right at the front at a front edge of a heating region and just in front of the operator control region 21. Said pot overlaps a large portion of the induction heating coils 15e and 15f. Said pot overlaps the pot detection sensor 25ef completely, and overlaps approximately 70% of the pot detection sensors 25ae and 25bf in each case. Said pot overlaps only 10% of the pot detection sensor 25ab and similarly of the induction heating coils 15a and 15b.

The major advantage of the elongate configuration of the pot detection sensors together with their similarly long air-core coils 40 is then that said pot detection sensors can distinguish between the three abovementioned different degrees of coverage, as it were as an above-mentioned analog signal. On account of the great length of the pot detection sensors 25, it can be expected that relatively large pots or pots which have not been set down wholly correctly lead to partial overlaps. Therefore, while the pot detection sensor 25ef supplies a signal corresponding to a full overlap, that is to say full signal strength, the pot detection sensors 25ae and 25bf supply a signal which is somewhat smaller than that of the pot detection sensor 25ef. However, it is nevertheless approximately half said signal strength or even somewhat more.

It is possible to detect from the pot detection sensor 25ab that there is slight coverage, but that said coverage is only slight and lies considerably below the abovementioned 50% overlap. This can also be registered from the induction heating coils 15a and 15b.

On the basis of this information, a controller of the induction hob 11, advantageously arranged in the operator control region 21, can calculate or determine the approximate size and position of the pot 45a. This would not be so readily possible with small pot detection sensors from the prior art according to the abovementioned document US 20160150600 A1 and, respectively, it would have been necessary to use considerably more pot detection sensors than the ten pot detection sensors illustrated here. As a result, the construction, arrangement and evaluation of said pot detection sensors is more complicated.

The smaller rear pot 45b overlaps the pot detection sensor 25bc completely. Therefore, said pot detection sensor supplies an overlap signal of maximum strength. The induction heating coils 15b and 15c also register that a pot has been set down over them, but they determine an overlap which is only approximately 25% in each case. Since the next front pot detection sensors 25bf and 25cg do not register anything, the position of the pot 45b can be approximately determined, as can its approximate size. Although this may not be quite so precisely possible as with the very large pot 45a, it is sufficient.

The smaller front pot 45c overlaps approximately two thirds of the induction heating coil 15g. The induction heating coil 15g can register this. Furthermore, approximately half of the pot detection sensor 25fg is overlapped, and said pot detection sensor can likewise register this. Since neither the pot detection sensor 25cg nor the pot detection sensor 25gh can establish overlap by the pot 25c or any pot, it is once again possible to approximately determine how big the pot 45d is and where it has been placed. Otherwise, it would particularly relatively quickly cover the pot detection sensor 25gh situated to the right thereof or overlap said pot detection sensor.

The very small pot 45d is placed onto the induction heating coil 15d at the back right and overlaps approximately 40% of said induction heating coil. Said induction heating coil can register this. Since the pot detection sensors 25cd and 25dh can register that they are not overlapped, it is clear that the pot 45d has to be relatively small. However, at the same time, said pot is sufficiently clearly placed over the induction heating coil 15d so that it can be homogeneously heated by said induction heating coil. The less than 50% coverage of the induction heating coil 15d still lies within an acceptable range, so that the pot 45d can be readily heated by means of this induction heating coil 15d. This also applies, in principle, to the pot 45c over the induction heating coil 15g.

The pot 45a can also be readily heated by means of the induction heating coils 15e and 15f. The induction heating coils 15a and 15b are no longer able to be readily used here because their overlap is simply too small. A similar situation can also be seen in the case of pot 45b, it being possible for the position of said pot to be approximately determined by means of the pot detection sensor 25bc. In the event of coverage of the induction heating coils 15b and 15c which is still too low, a fault would be reported and, respectively, a heating operation would not be started and the operator would be informed accordingly and advised to move the pot 45b.

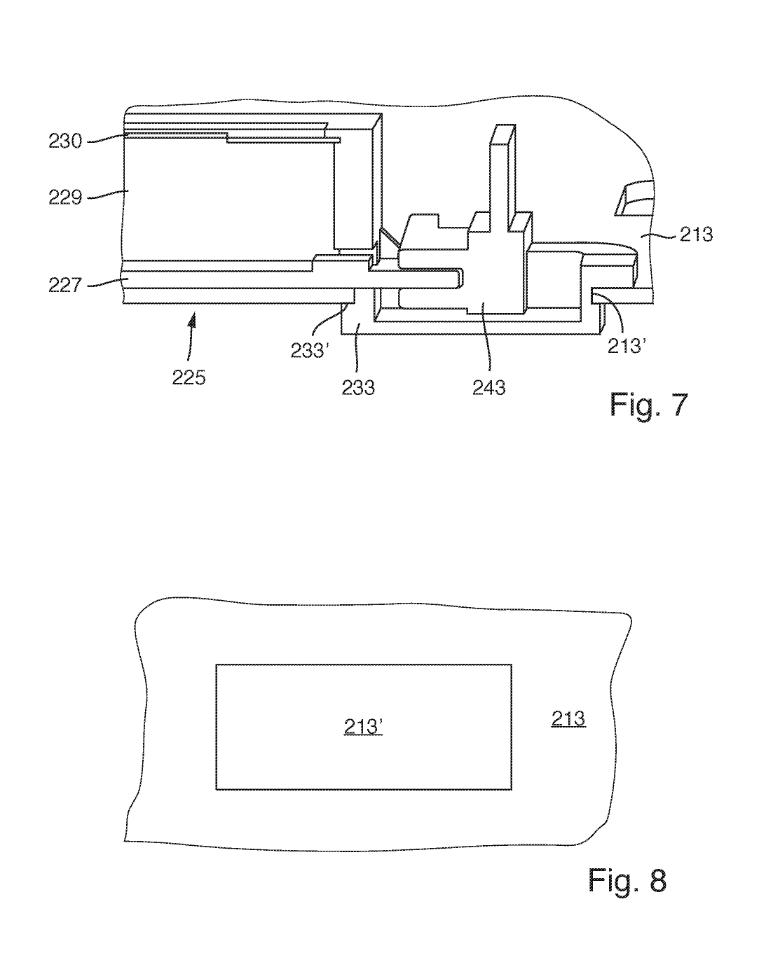

FIG. 7 shows a detail of a yet further refinement of a pot detection sensor 225 in which a relatively small housing is not arranged on a relatively large printed circuit board, but rather in which a relatively small printed circuit board 227 is arranged, as it were, in the relatively large housing 229 and protrudes only by a small portion. A connection plug 243 is plug-mounted over this protruding end of the printed circuit board 227, and contact areas can be provided on the printed circuit board 227 for this purpose, similarly to FIG. 3. In order to create a sufficient amount of space for the connection plug 243 and also for fastening the pot detection sensor 225 on the carrying plate 213, cutouts 213′ of rectangular shape are provided in said carrying plate, as can be seen in the plan view according to FIG. 8. One single cutout 213′ of this kind is sufficient for each pot detection sensor 225, but two, one at each end, is advantageous.

A recessed or pulled-down fastening shoe 233 protrudes from the housing 229 on the right-hand side. Said fastening shoe has a peripheral incision 233′. If the housing 229 is manufactured from a highly elastic material such as silicone or the like here, the fastening shoe 233 can be pushed into the recess 213′ relatively easily, so that the peripheral edges of said recess engage into the incision 233′. This produces an interlocking connection which can be released again by elastic deformation but is sufficient for assembly and operation of the induction hob. The fastening shoe 233 which is open at the top also has enough space for the connection plug 243. In particular, this connection plug 243 can also be plug-mounted onto the printed circuit board 227 only afterward.

Here, it can further be seen in respect of the housing 229 that said housing, in the upper region, has a separate top side 230 as a thin plate which is held on said housing by being plugged in or latched in. The thin plate as the top side 230 can be composed of translucent material for diffusor properties and have corresponding cutouts through which special light phenomena can be produced at the top, as has been explained above.

An abovementioned elongate and narrow illumination device as an alternative, fundamental and advantageous refinement of the invention could be designed as illustrated in FIGS. 2 and 3 or 7, but just without the air-core coil for pot detection. Said lighting device could also have correspondingly designed transparent cutouts or the like, advantageously as elongate slots, on a top side of a housing. Therefore, said lighting device can optically separate the individual induction heating coils 15 from one another in the event of illumination of same. This can facilitate correct setting down of cooking vessels.

1. Pot detection sensor for an induction hob, wherein said pot detection sensor has:
an air-core coil with at least two turns,
a carrier for said air-core coil,
wherein a length of said air-core coil is at least five times a width of said air-core coil.

2. Pot detection sensor according to claim 1, wherein said carrier is flat and said turns of said air-core coil run parallel to said carrier.

3. Pot detection sensor according to claim 1, wherein said air-core coil is straight.

4. Pot detection sensor according to claim 1, wherein said carrier is straight.

5. Pot detection sensor according to claim 1, wherein the air-core coil is bent.

6. Pot detection sensor according to claim 1, wherein said carrier is bent.

7. Pot detection sensor according to claim 1, wherein said length of said air-core coil is between eight times and twelve times said width of said air-core coil.

8. Pot detection sensor according to claim 1, wherein said carrier has two opposite flat sides, wherein on one of said flat sides components are provided, wherein said air-core coil is arranged on the same flat side as said components.

9. Pot detection sensor according to claim 8, wherein said other flat side of said carrier is free of said components.

10. Pot detection sensor according to claim 1, wherein a temperature sensor is provided on a top side of said pot detection sensor or on a bottom side of said pot detection sensor.

11. Pot detection sensor according to claim 1, wherein a bus controller is provided, which is arranged on said carrier.

12. Pot detection sensor according to claim 1, wherein lighting means are provided on said same flat side of the carrier on which said air-core coil is also arranged.

13. Pot detection sensor according to claim 12, wherein said lighting means are surrounded by said air-core coil.

14. Pot detection sensor according to claim 12, wherein diffusor means are arranged over said at least one lighting means for a purpose of generating a diffuse light phenomenon or for equalizing a lighting effect of said at least one lighting means.

15. Pot detection sensor according to claim 14, wherein said diffusor means is at least one portion of a housing, which is formed over said at least one lighting means and also around said at least one lighting means.

16. Pot detection sensor according to claim 12, wherein said air-core coil, by way of its turns, is wound around a housing or around a cover for said at least one lighting means, wherein said air-core coil is wound in such a way that said housing or said cover carry or support said air-core coil.

17. Pot detection sensor according to claim 1, wherein at least two identical air-core coils are arranged in an extension to one another on said carrier.

18. Pot detection sensor according to claim 17, wherein said at least two identical air-core coils are arranged at a distance of 1 cm to at most 5 cm from one another.

19. Induction hob comprising at least one pot detection sensor according to claim 1, wherein said induction hob has:
a hob plate,
at least one induction heating coil beneath said hob plate,
at least one pot detection sensor along an outer side of said induction heating coil.

20. Induction hob according to claim 19, wherein said pot detection sensor does not overlap either a surface of said induction heating coil or one of said turns of said induction heating coil.

21. Induction hob according to claim 19, wherein said pot detection sensor, by way of its carrier, also does not overlap either a surface of said induction heating coil or one of said turns of said induction heating coil.

22. Induction hob according to claim 19, wherein it has a plurality of induction heating coils, wherein one said pot detection sensor is arranged between adjacent of said induction heating coils.

23. Induction hob according to claim 22, wherein precisely one single pot detection sensor is arranged between precisely two adjacent of said induction heating coils.

24. Induction hob according to claim 19, wherein pot detection sensors are arranged only along those longitudinal sides of induction heating coils which are not directed toward an outside and which have an adjacent induction heating coil.

25. Induction hob according to claim 19, wherein said induction heating coils are in a shape of a rectangle with substantially straight outer sides.
